(19) United States
(12) Patent Application Publication
(10) Pub. No.: US 2024/0205561 A1
(43) Pub. Date: Jun. 20, 2024

(54) READOUT CIRCUIT SUPPORTING BINNING MODE AND DYNAMIC VISION SENSOR INCLUDING THE SAME

(71) Applicant: SAMSUNG ELECTRONICS CO., LTD., Suwon-si (KR)

(72) Inventors: Bongki SON, Suwon-si (KR); Junseok KIM, Suwon-si (KR); Keunjoo PARK, Suwon-si (KR)

(73) Assignee: SAMSUNG ELECTRONICS CO., LTD., Suwon-si (KR)

(21) Appl. No.: 18/543,583

(22) Filed: Dec. 18, 2023

(30) Foreign Application Priority Data
Dec. 20, 2022 (KR) 10-2022-0179808

(51) Int. Cl. H04N 25/766; H04N 25/771; H04N 25/778

(52) U.S. Cl. CPC H04N 25/766; H04N 25/771; H04N 25/778

(57) ABSTRACT

Provided is a dynamic vision sensor. The dynamic vision sensor includes: a pixel array including a plurality of pixels arranged in a plurality of rows and a plurality of columns, wherein each of the plurality of pixels is configured to detect a change in intensity of incident light; and a readout circuit configured to simultaneously select first pixels of first target columns among the plurality of columns in a first section of a binning operation, and generate and output first binning event signals of first binning pixel groups based on first event signals simultaneously output from the first pixels.

### CROSS-REFERENCE TO RELATED APPLICATION

This application claims priority to Korean Patent Application No. 10-2022-0179808, filed on Dec. 20, 2022, in the Korean Intellectual Property Office, the disclosure of which is incorporated by reference herein in its entirety.

### BACKGROUND

The present disclosure relates to a dynamic vision sensor and, more specifically, to a dynamic vision sensor including a readout circuit.

Complementary metal-oxide semiconductor (CMOS) image sensors and dynamic vision sensors are different types of image sensors. The CMOS image sensor provides captured images to a processor as is, but requires a large amount of data processing. The dynamic vision sensor may reduce the amount of data to be processed by detecting only events in which the intensity of light changes, and providing the detected events to the processor.

There is a need for a dynamic vision sensor that supports both a relatively low-speed frame operation and a relative high-speed frame operation of an image device. However, related dynamic vision sensors are unable to support the relatively high-speed frame operation.

### SUMMARY

One or more example embodiments provide a readout circuit capable of supporting both a low-speed and a high-speed frame operation of an image device by operating in any one of a normal mode and a binning mode, and a dynamic vision sensor including the same.

According to an aspect of an example embodiment, a dynamic vision sensor includes: a pixel array with a plurality of pixels arranged in a plurality of rows and a plurality of columns, wherein each of the plurality of pixels is configured to detect a change in intensity of incident light; and a readout circuit configured to simultaneously select first pixels of first target columns among the plurality of columns in a first section of a binning operation, and generate and output first binning event signals of first binning pixel groups based on first event signals simultaneously output from the first pixels.

According to another aspect of an example embodiment, a dynamic vision sensor includes: a first dynamic vision sensor (DVS) pixel connected to a first column line, a first on-row line, and a first off-row line; a second DVS pixel connected to the first column line, a second on-row line, and a second off-row line; a third DVS pixel connected to a second column line, the first on-row line, and the first off-row line; a fourth DVS pixel connected to the second column line, the second on-row line, and the second off-row line; a first readout sub-circuit including a first multiplexer configured to select a selected signal from among a first column selection signal and a second column selection signal applied to the first column line based on a mode of the dynamic vision sensor, and output the selected signal to the second column line; and a second readout sub-circuit including: a first OR gate connected to the first on-row line and the second on-row line through inputs; a second multiplexer configured to select and output one of an output of the first OR gate and a signal of the first on-row line based on the mode; a second OR gate connected to the first off-row line and the second off-row line through inputs; a third multiplexer configured to select and output one of an output of the second OR gate and a signal of the first off-row line based on the mode; a first AND gate configured to selectively output a signal of the second on-row line based on the mode; and a second AND gate configured to selectively output a signal of the second off-row line based on the mode.

In addition, according to another aspect of an example embodiment, a dynamic vision sensor includes: a pixel array including a plurality of pixels arranged in a plurality of rows and a plurality of columns, wherein each of the plurality of pixels is configured to detect a change in intensity of incident light; and a readout circuit configured to sequentially select binning pixel groups of the plurality of pixels in units of columns in a binning operation and generate and output binning event signals of the binning pixel groups based on a plurality of event signals output from the binning pixel groups.

### BRIEF DESCRIPTION OF DRAWINGS

The above and other aspects and features will be more apparent from the following description of example embodiments, taken in conjunction with the accompanying drawings, in which:

FIG. 1 is a schematic block diagram of an image device according to an example embodiment;

FIG. 2 is a flowchart illustrating a method of operating a dynamic vision sensor according to an example embodiment;

FIGS. 3A and 3B are block diagrams specifically illustrating a dynamic vision sensor according to an example embodiment;

FIG. 4 is a block diagram specifically illustrating a dynamic vision sensor according to an example embodiment;

FIGS. 5A, 5B and 5C are diagrams illustrating binning pixel groups according to example embodiments, respectively;

FIG. 6A is a flowchart illustrating a method of operating a dynamic vision sensor according to an example embodiment, and FIG. 6B is a diagram illustrating a binning pixel group according to a plurality of types of the binning mode of FIG. 6A;

FIG. 7A is a diagram showing the structure of a pixel of a dynamic vision sensor according to an example embodiment, and FIG. 7B is a diagram specifically showing the event detection circuit of FIG. 7A;

FIG. 8 is a detailed block diagram of a dynamic vision sensor according to an example embodiment;

FIG. 9A is a diagram for explaining the operation of the dynamic vision sensor of FIG. 8 in a first section of the binning mode, and FIG. 9B is a diagram for explaining the operation of the dynamic vision sensor of FIG. 8 in a second section of the binning mode;

FIG. 10A is a diagram for explaining the operation of the dynamic vision sensor of FIG. 8 in a first section of the normal mode, and FIG. 10B is a diagram for explaining the operation of the dynamic vision sensor of FIG. 8 in a second section of the normal mode;

FIG. 11 is a detailed block diagram of a dynamic vision sensor according to an example embodiment;

FIG. 12 is a flowchart illustrating a method of operating a dynamic vision sensor in a binning mode according to an example embodiment; and

FIG. 13 is a block diagram illustrating an electronic device according to an example embodiment.

### DETAILED DESCRIPTION

Example embodiments will be described with reference to the accompanying drawings. Embodiments described herein are provided as examples, and thus, the present disclosure is not limited thereto, and may be realized in various other forms. Each example embodiment provided in the following description is not excluded from being associated with one or more features of another example or another embodiment also provided herein or not provided herein but consistent with the present disclosure. The components described with reference to terms such as a portion, a part, a unit, a module, a block, a device derived with a suffix such as “or” and “er” used in the detailed description, and functional blocks illustrated in the drawings may be implemented in software, hardware, or a combination thereof. For example, the software may be machine code, firmware, embedded code, and application software. For example, hardware may include electrical circuits, electronic circuits, processors, computers, integrated circuits, integrated circuit cores, pressure sensors, inertial sensors, microelectromechanical systems (MEMS), passive devices, or a combination thereof. Furthermore, a first component that described as being connected to a second component includes a case in which the two components are connected with a third component placed therebetween.

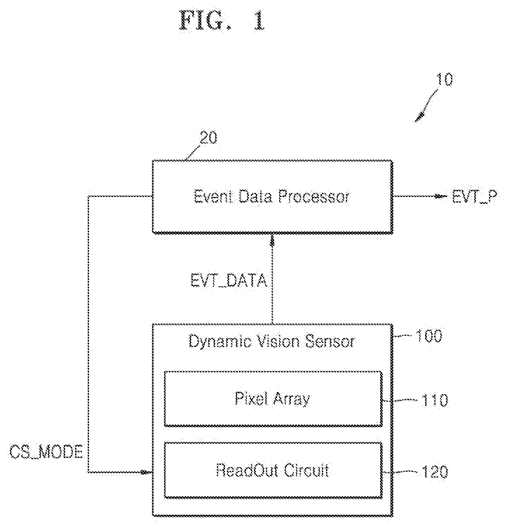

FIG. 1 is a schematic block diagram of an image device 10 according to an example embodiment.

Referring to FIG. 1, the image device 10 may include an event data processor 20 and a dynamic vision sensor 100. The event data processor 20 may process event data EVT_DATA output from the dynamic vision sensor 100 to generate an event packet EVT_P. In some example embodiments, the event data processor 20 may be referred to as an event signal processor.

The event data processor 20 may perform various processes on the event data EVT_DATA. For example, the event data processor 20 may correct the timestamp value of a noise pixel, a hot pixel, or a dead pixel using a temporal correlation of the timestamp values of pixels of the pixel array 110 of the dynamic vision sensor 100.

In an example embodiment, the image device 10 may generate an image based on the event packet EVT_P.

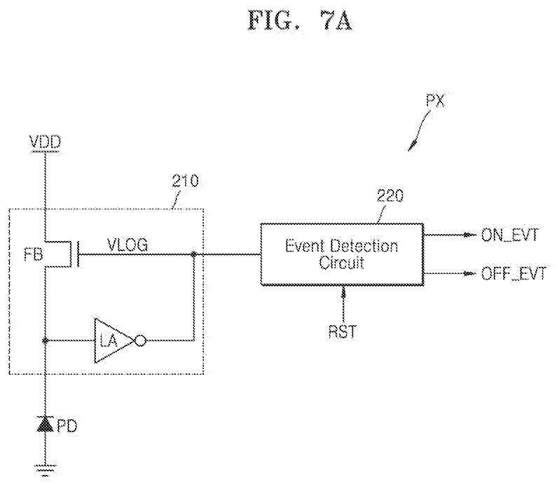

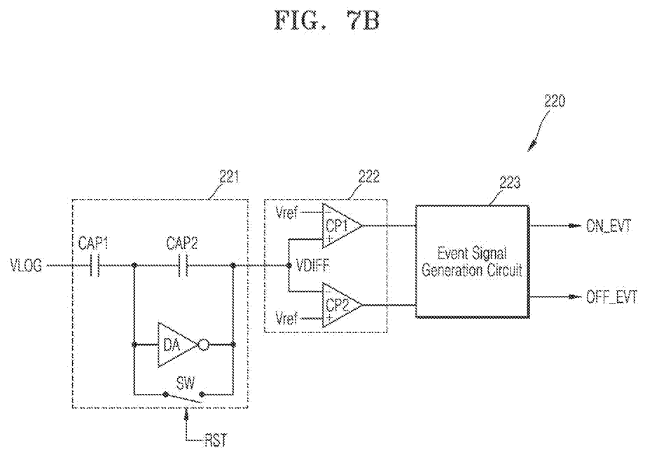

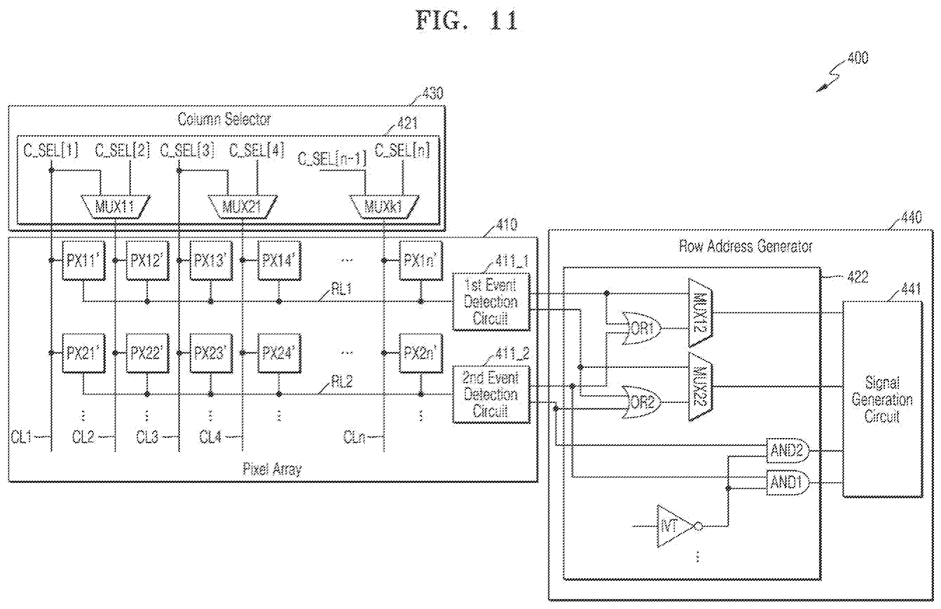

In an example embodiment, the dynamic vision sensor 100 may include a pixel array 110 and a readout circuit 120. The pixel array 110 may include pixels arranged in a plurality of rows and a plurality of columns. The structure of the pixel of the dynamic vision sensor 100 may be different from the structure of the pixel of a general CMOS image sensor. A structure of a pixel consistent with example embodiments is applied will be described in detail with reference to FIGS. 7A, 7B, and 11. The pixel array 110 may generate event signals for each pixel by sensing a change in the intensity of light incident on each pixel.

The event signal may include an on-event signal and an off-event signal. For example, when the light intensity of the pixel increases by more than a reference value, the event signal corresponding to the pixel may include an on-event signal of logic high (H) and an off-event signal of logic low (L). For example, when the light intensity of the pixel decreases by more than the reference value, the event signal corresponding to the pixel may include an on-event signal of logic low (L) and an off-event signal of logic high (H). For example, when the light intensity of the pixel increases by less than the reference value, or decreases by less than the reference value, the event signal corresponding to the pixel may include an on-event signal of logic low (L) and an off-event signal of logic low (L). However, this is provided as an example and example embodiments are not limited thereto. Depending on the structure of the pixel array 110 and the readout circuit 120, the on-event signal and the off-event signal may have various logical values.

As an example, the readout circuit 120 may operate in either a normal mode or a binning mode based on a mode control signal CS_MODE received from the event data processor 20 to read out event signals from the pixel array 110. For example, the event data processor 20 may provide a binning mode control signal to the dynamic vision sensor 100 so that readout circuit 120 operates in the binning mode for high-speed frame operation. For example, the event data processor 20 may provide a normal mode control signal to the dynamic vision sensor 100 so that readout circuit 120 operates in the normal mode for low-speed frame operation.

As an example, the readout circuit 120 may sequentially select pixels of the pixel array 110 in the binning mode in units of column groups, each of the column groups including at least two columns, or in units of row groups, each of the row groups including at least two rows. The readout circuit 120 may receive event signals corresponding to the selected pixels from the pixel array 110, and generate binning event signals of the binning pixel groups from the received event signals and output the generated binning event signals. As used herein, the binning pixel group may be defined by grouping at least four pixels in the binning mode, and one binning event signal (consisting of one binning on-event signal and one binning off-event signal) may be generated and output for the binning pixel group.

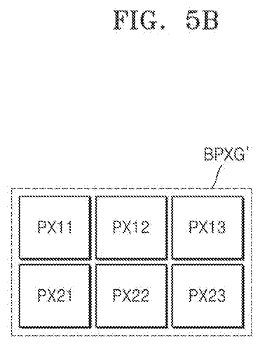

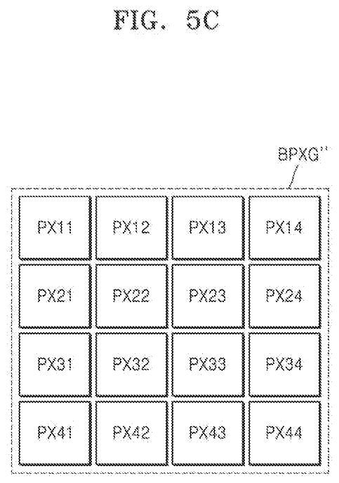

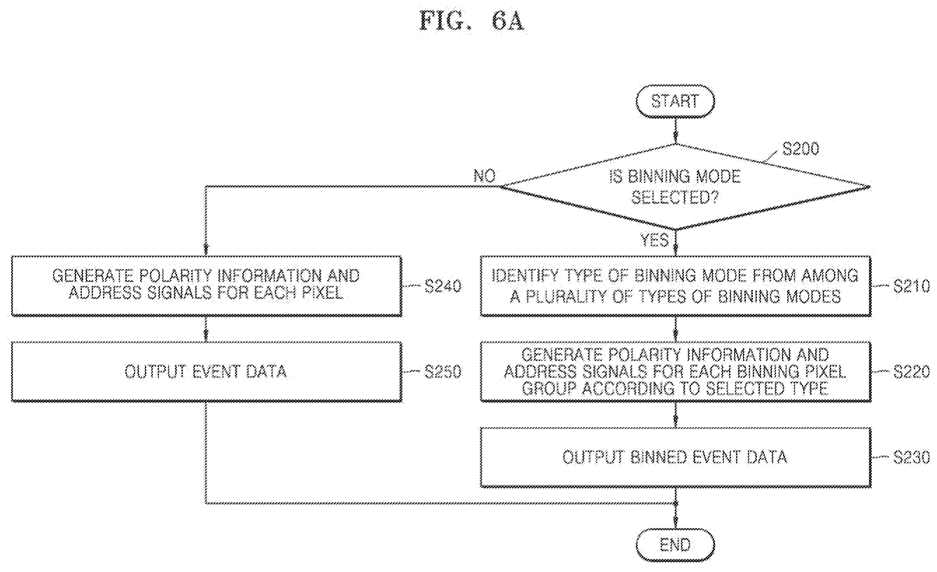

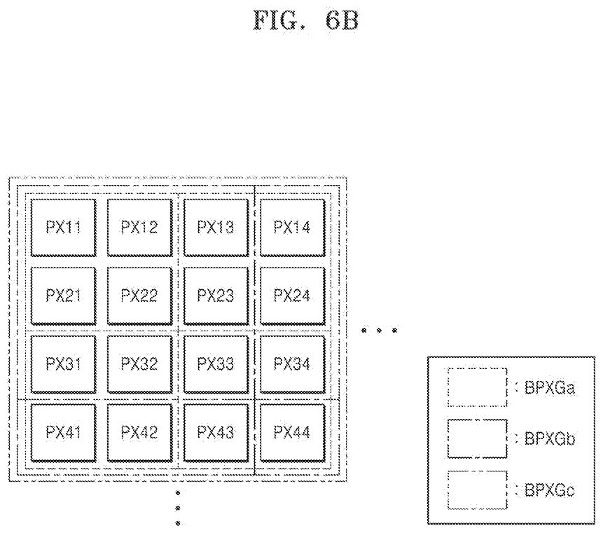

In an example embodiment, the binning pixel group may include pixels arranged in M×N (where each of M and N is an integer of 2 or more). In some example embodiments, the binning mode may be defined as a plurality of types, and the number of pixels included in the binning pixel group may vary depending on the type of the binning mode. Specific examples of the binning pixel group will be described later with reference to FIGS. 5A to 5C and 6B.

As an example, the readout circuit 120 may sequentially select the pixels of the pixel array 110 in units of columns (or rows) in the normal mode, receive event signals corresponding to the selected pixels from the pixel array 110 and output the event signals in units of rows (or columns).

The binning event signal or event signal output from the readout circuit 120 may be provided to an output buffer along with address signals as polarity information.

In the binning mode, the dynamic vision sensor 100 may generate binned event data EVT_DATA based on binning event signals output from the readout circuit 120. The binned data may be understood as binning-processed data. In addition, the dynamic vision sensor 100 may generate event data (EVT_DATA) based on event signals output from the readout circuit 120 in the normal mode.

The readout circuit 120 may process event signals output from the pixel array 110 in the binning mode in units of binning pixel groups to generate binning event signals with a reduced amount of data. As a result, the amount of event data (EVT_DATA) caused by binning event signals is reduced, and the event data processor (20) can effectively perform high-speed frame operations by quickly processing a small amount of event data (EVT_DATA).

In addition, the readout circuit 120 may operate in either the binning mode or the normal mode to support both high-speed and low-speed frame operations of the event data processor 20. Accordingly, the image device 10 may generate a high-resolution image according to a user's request or generate a low-resolution image at low power, thereby providing high flexibility to the user.

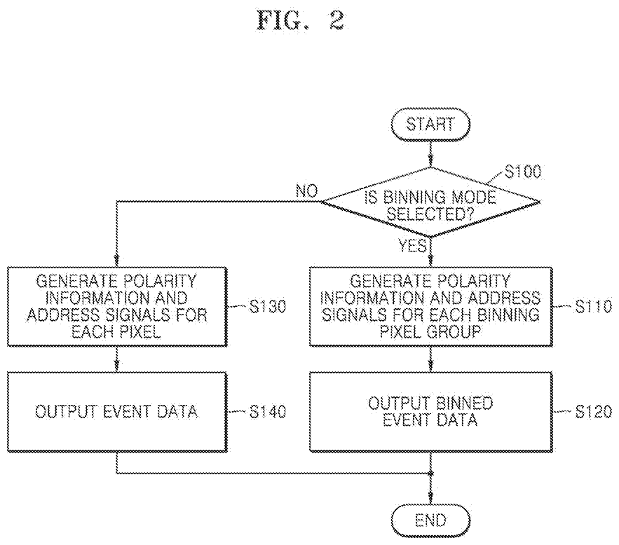

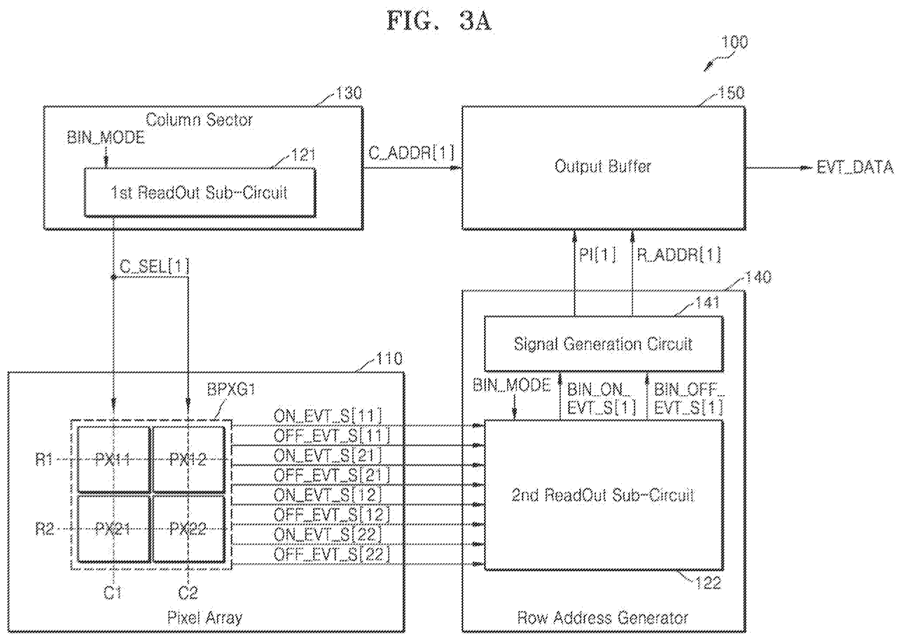

FIG. 2 is a flowchart illustrating a method of operating a dynamic vision sensor according to an example embodiment.

Referring to FIG. 2, when the binning mode is selected as YES in S100, the dynamic vision sensor may perform operation S110 and S120, and when the normal mode is selected as NO in S100, the dynamic vision sensor may perform operations S130 and S140.

In an example embodiment, the dynamic vision sensor may operate in the binning mode or the normal mode under the control of the event data processor. Specifically, the dynamic vision sensor may operate in a selected mode according to a mode control signal received from the event data processor.

In operation S110, the dynamic vision sensor may generate polarity information for each binning pixel group and address signals corresponding thereto from event signals output from the pixel array.

In operation S120, the dynamic vision sensor may generate binned event data based on the polarity information and address signals generated in operation S110 and output the binned event data to the event data processor.

In operation S130, the dynamic vision sensor may generate polarity information for each pixel and address signals corresponding thereto from event signals output from the pixel array.

In operation S140, the dynamic vision sensor may generate event data based on the polarity information and address signals generated in operation S130 and output the event data to the event data processor.

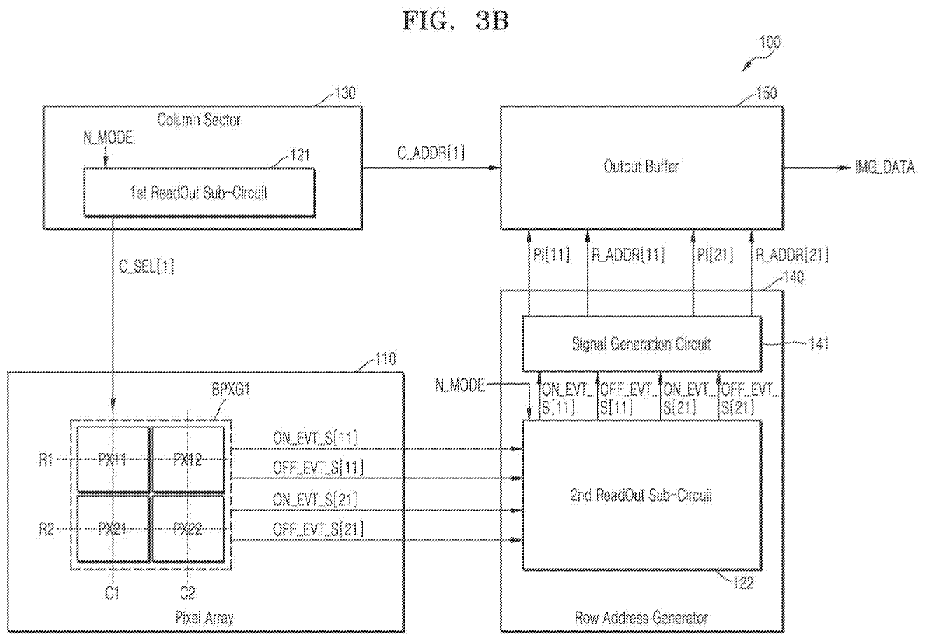

FIGS. 3A and 3B are block diagrams specifically illustrating a dynamic vision sensor 100 according to an example embodiment. It is assumed that the dynamic vision sensor 100 of FIG. 3A operates in the binning mode, and the dynamic vision sensor 100 of FIG. 3B operates in the normal mode.

Referring to FIG. 3A, the dynamic vision sensor 100 may include a pixel array 110, a column selector 130, a row address generator 140 and an output buffer 150.

In an example embodiment, the readout circuit 120 of FIG. 1 may include a first readout sub-circuit 121 and a second readout sub-circuit 122 in FIG. 3A. The first readout sub-circuit 121 may be included in the column selector 130 or may be implemented to be arranged adjacent to the column selector 130. The second readout sub-circuit 122 may be included in the row address generator 140 or may be arranged adjacent to the row address generator 140.

In FIGS. 3A and 3B, example embodiments are described with respect to the case that the first readout sub-circuit 121 is included in the column selector 130, and the second readout sub-circuit 122 is included in the row address generator 140. The column selector 130 may be referred to as a column address generator.

In an example embodiment, the first and second readout sub-circuits 121 and 122 are implemented as digital circuits and may be designed as register transfer level (RTL) tools. In some example embodiments, the first and second readout sub-circuits 121 and 122 may be implemented as analog circuits.

The pixel array 110 may include a plurality of pixels, and the plurality of pixels may be grouped as a binning pixel group. For example, the binning pixel group may include pixels arranged in 2×2 (i.e., two rows and two columns). For example, the first binning pixel group BPXG1 may include first to fourth pixels PX11, PX21, PX12, and PX22. The first and second pixels PX11 and PX21 may be arranged in a first column C1, and the third and fourth pixels PX12 and PX22 may be arranged in a second column C2. The first and third pixels PX11 and P12 may be arranged in a first row R1, and the second and fourth pixels PX21 and PX22 may be arranged in a second row R2.

In an example embodiment, the first readout sub-circuit 121 may perform routing so as to apply a first column selection signal C_SEL[1] generated by the column selector 130 to the first and second pixels PX11 and PX21 arranged in the first column C1, and the third and fourth pixels PX12 and PX22 arranged in the second column C2, based on a binning mode control signal BIN_MODE. In an example embodiment, the first readout sub-circuit 121 may include a multiplexer that selectively outputs either the first column selection signal C_SEL[1] or a second column selection signal to the third and fourth pixels PX12 and PX22 arranged in the second column C2 based on the selected mode.

In an example embodiment, the first pixel PX11 may output a first event signal in response to a first column selection signal C_SEL[1]. The first event signal may include a first on-event signal ON_EVT_S[11] and a first off-event signal OFF_EVT_S[11]. The second pixel PX21 may output a second event signal in response to the first column selection signal C_SEL[1]. The second event signal may include a second on-event signal ON_EVT_S[21] and a second off-event signal OFF_EVT_S[21]. The third pixel PX12 may output a third event signal in response to the first column selection signal C_SEL[1]. The third event signal may include a third on-event signal ON_EVT_S[12] and a third off-event signal OFF_EVT_S[12]. The fourth pixel PX22 may output a fourth event signal in response to the first column selection signal C_SEL[1]. The fourth event signal may include a fourth on-event signal ON_EVT_S[22] and a fourth off-event signal OFF_EVT_S[22]. That is, the first to fourth pixels PX11, PX21, PX12, and PX22 simultaneously selected by the first column selection signal C_SEL[1] may output the first to fourth event signals to the second readout sub-circuit 122, respectively.

In an example embodiment, based on the binning mode control signal BIN_MODE, the second readout sub-circuit 122 may be configured to generate a first binning on-event signal BIN_ON_EVT_S[11] from the first to fourth on-event signals ON_EVT_S[11], ON_EVT_S[21], ON_EVT_S[12], ON_EVT_S[22], and generate a first binning off-event signal BIN_OFF_EVT_S[11], from the first to fourth off-event signals OFF_EVT_S[11], OFF_EVT_S[21], OFF_EVT_S[12], and OFF_EVT_S[22].

In an example embodiment, the second readout sub-circuit 122 may generate the first binning on-event signal BIN-ON-EVT_S[1] through OR operations or sum operations for the first to fourth on-event signals ON_EVT_S[11], ON_EVT_S[21], ON_EVT_S[12], and ON_EVT_S[22]. In addition, the second readout sub-circuit 122 may generate the first binning off-event signal BIN-OFF-EVT_S[1] through OR operations or sum operations for the first to fourth off-event signals OFF_EVT_S[11], OFF_EVT_S[21], OFF_EVT_S[12], and OFF_EVT_S[22]. In an example embodiment, the second readout sub-circuit 122 may include a plurality of multiplexers, a plurality of OR gates, and a plurality of AND gates.

In an example embodiment, the row address generator 140 may include a signal generation circuit 141. The signal generation circuit 141 may generate first polarity information PI[1] corresponding to the first binning pixel group BPXG1 and a first row address signal R_ADDR[1] corresponding to the first polarity information based on the first binning on-event signal BIN_ON_EVT_S[1] and the first binning off-event signal BIN_OFF_EVT_S[1] received from the second readout sub-circuit 122. In an example embodiment, the first row address signal R_ADDR[1] may correspond to the row address of any one of the first to fourth pixels PX11, PX21, PX12, and PX22. For example, the first row address signal R_ADDR[1] may correspond to the first row R1.

In an example embodiment, the column selector 130 may generate a first column address signal C_ADDR[1] corresponding to the first binning pixel group BPXG1. In an example embodiment, the first column address signal C_ADDR[1] may correspond to the column address of any one of the first to fourth pixels PX11, PX21, PX12, and PX22. For example, the first column address signal C_ADDR[1] may correspond to the first column C1.

In an example embodiment, the output buffer 150 may generate event data EVT_DATA based on the first column address signal C_ADDR[1], the first row address signal R_ADDR[1], and the first polarity information PI[1].

Referring to FIG. 3B, the first readout sub-circuit 121 may perform routing so as to apply a first column selection signal C_SEL[1] generated by the column selector 130 to only the first and second pixels PX11 and PX21 arranged in the first column C1, based on a normal mode control signal N_MODE. In this regard, the first column selection signal C_SEL[1] may not be applied to the third and fourth pixels PX12 and PX22.

In an example embodiment, the first pixel PX11 may output a first event signal in response to a first column selection signal C_SEL[1]. The first event signal may include a first on-event signal ON_EVT_S[11] and a first off-event signal OFF_EVT_S[11]. The second pixel PX21 may output a second event signal in response to the first column selection signal C_SEL[1]. The second event signal may include a second on-event signal ON_EVT_S[21] and a second off-event signal OFF_EVT_S[21].

In an example embodiment, the second readout sub-circuit 122 may transmit a first on-event signal ON_EVT_S[11], a first off-event signal OFF_EVT_S[11], a second on-event signal ON_EVT_S[21] and a second off-event signal OFF_EVT_S[21] to the signal generation circuit 141, based on the normal mode control signal N_MODE.

In an example embodiment, the column selector 130 may generate a first column address signal C_ADDR[1] corresponding to the first column selection signal C_SEL[1].

In an example embodiment, the signal generation circuit 141 may generate first polarity information PI[11] corresponding to the first pixel PX11 and a first row address signal R_ADDR[11] corresponding to the first polarity information PI[11]. The signal generation circuit 141 may generate second polarity information PI[21] corresponding to the second pixel PX21 and a second row address signal R_ADDR[21] corresponding to the second polarity information PI[21].

In an example embodiment, the output buffer 150 may generate event data EVT_DATA based on the first column address signal C_ADDR[1], the first polarity information PI[11], the second polarity information PI[21], the first row address signal R_ADDR[11] and the second row address signal R_ADDR[21].

As shown in FIGS. 3A and 3B, the amount of data generated when the dynamic vision sensor 100 operates in the binning mode may be less than the amount of data generated when operating in the normal mode. The dynamic vision sensor 100 in the binning mode may be suitable for a low power operation or an operation of an image device for generating a low resolution image. In addition, the dynamic vision sensor 100 in the binning mode may be suitable for high-speed frame operation due to a small amount of data.

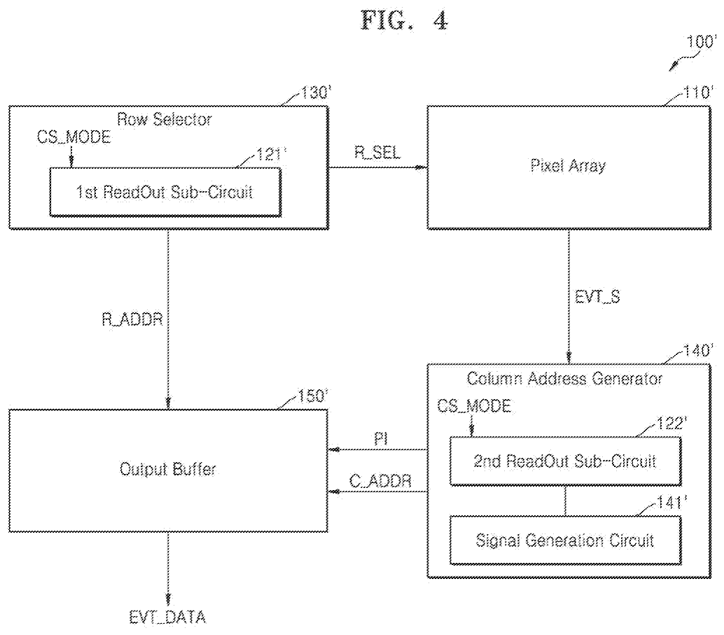

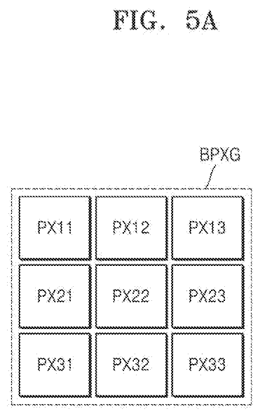

FIG. 4 is a block diagram specifically illustrating a dynamic vision sensor 100′ according to an example embodiment. The dynamic vision sensor 100′ of FIG. 4 may be an example embodiment in which pixels are selected by a row selector 130′ and polarity information is generated by a column address generator 140′. It will be easily understood that the technical idea of the present disclosure may be sufficiently applied to the implementation as shown in FIG. 4.

Referring to FIG. 4, the dynamic vision sensor 100′ may include a pixel array 110′, a row selector 130′, a column address generator 140′, and an output buffer 150′. In an example embodiment, a first readout sub-circuit 121′ may be included in the row selector 130′, and a second readout sub-circuit 122′ may be included in the column address generator 140′.

In an example embodiment, the first readout sub-circuit 121′ may route a row selection signal R_SEL to pixels arranged in at least one row based on a mode control signal CS_MODE. In addition, the first readout sub-circuit 121′ may generate a row address signal R_ADDR corresponding to the row selection signal R_SEL and output the generated result to the output buffer 150′.

In an example embodiment, the pixel array 110′ may output event signals EVT_S corresponding to pixels selected by the row selection signal R_SEL among a plurality of pixels.

In an example embodiment, the second readout sub-circuit 122′ may generate binning event signals from the event signals EVT_S based on the mode control signal CS_MODE, or may transmit the event signals EVT_S to the signal generation circuit 141′.

In an example embodiment, the signal generation circuit 141′ may generate polarity information PI and a column address signal C_ADDR corresponding to the polarity information PI based on the binning event signals or event signals EVT_S received from the second readout sub-circuit 122′, and output the generated result to the output buffer 150′.

In an example embodiment, the output buffer 150′ may generate event data EVT_DATA based on the row address signal R_ADDR, the column address signal C_ADDR, and the polarity information PI.

In the following, example embodiments are described while focusing on the structure of the dynamic vision sensor 100 in FIG. 3A, but it will be fully understood that the technical idea of the present disclosure may also be applied to the structure of the dynamic vision sensor 100′ in FIG. 4.

FIGS. 5A to 5C are diagrams illustrating binning pixel groups BPXG, BPXG′, and BPXG″ according to example embodiments, respectively.

Referring to FIG. 5A, the binning pixel group BPXG may include first to ninth pixels P11, PX21, PX31, PX12, PX22, PX32, PX13, PX23, and PX33 arranged in 3×3 (i.e., three rows and three columns). That is, the binning pixel group BPXG includes nine pixels, and one binning event signal (including binning on-event signal and binning off-event signal) may be generated per nine pixels in the binning mode.

Referring to FIG. 5B, the binning pixel group BPXG′ may include first to sixth pixels P11, PX21, PX12, PX22, PX13, and PX23 arranged in 2×3 (i.e., two rows and three columns). That is, the binning pixel group BPXG′ includes six pixels, and one binning event signal may be generated per six pixels in the binning mode.

Referring further to FIG. 5C, the binning pixel group BPXG″ may include first to sixteenth pixels PX11, PX21, PX31, PX41, PX12, PX22, PX32, PX42, PX13, PX23, PX33, PX43, PX14, PX24, PX34, and PX44 arranged in 4×4 (i.e., four rows and four columns). That is, the binning pixel group BPXG″ includes 16 pixels, and one binning event signal may be generated per 16 pixels in the binning mode.

However, the binning pixel groups BPXG, BPXG′, and BPXG″ shown in FIGS. 5A to 5C are only examples and example embodiments are not limited thereto, and more various types of binning pixel groups may be defined. The readout circuit may be implemented to simultaneously select pixels corresponding to the defined binning pixel group and generate binning event signals from event signals corresponding to the selected pixels.

FIG. 6A is a flowchart illustrating a method of operating a dynamic vision sensor according to an example embodiment, and FIG. 6B is a diagram illustrating binning pixel groups BPXGa, BPXGb, and BPXGc according to a plurality of types of binning groups of the binning mode of FIG. 6A.

Referring to FIG. 6A, when the binning mode is selected as YES in S200, the dynamic vision sensor may perform operations S210 to S230, and when the normal mode is selected as NO in S200, the dynamic vision sensor may perform operations S240 and S250.

In operation S210, the dynamic vision sensor may identify (e.g., select) a type of binning mode from among a plurality of types of binning modes. In an example embodiment, the dynamic vision sensor may select a type of binning mode indicated by the event data processor from among the plurality of types of binning modes. For example, the binning mode may include first to third types of binning modes.

Referring further to FIG. 6B, the binning pixel group BPXGa corresponding to the first type may include four pixels arranged in 2×2, the binning pixel group BPXGb corresponding to the second type may include nine pixels arranged in 3×3, and the binning pixel group BPXGc corresponding to the third type may include 16 pixels arranged in 4×4.

For example, in the first type of binning mode, the first, second, fifth, and sixth pixels PX11, PX21, PX12, and PX22, the third, fourth, seventh, and eighth pixels PX31, PX41, PX32, and PX42, the ninth, tenth, thirteenth, and fourteenth pixels PX13, PX23, PX14, and PX24, and the eleventh, twelfth, fifteenth, and sixteenth pixels PX33, PX43, PX34, and PX44 may be grouped into different binning pixel groups, respectively.

For example, in the second type of binning mode, the first, second, third, fifth, sixth, seventh, ninth, tenth, and eleventh pixels PX11, PX21, PX31, PX12, PX22, PX32, PX13, PX23, and PX33, the fourth, eighth, and twelfth pixels PX41, PX42, and PX43, thirteenth, fourteenth, and fifteenth pixels PX14, PX24, and PX34, the sixteenth pixel PX44 may be grouped into different binning pixel groups BPXGb, respectively.

For example, in the third type of binning mode, the first to sixteenth pixels PX11, PX21, PX31, PX12, PX22, PX32, PX42, PX13, PX23, PX33, PX43, PX14, PX24, PX34, and PX44 may be grouped into one binning pixel group BPXGc.

However, FIG. 6B illustrates only an example, and example embodiments are not limited thereto, and there are fewer or more types, and binning pixel groups may be variously defined according to various types.

Referring back to FIG. 6A, in operation S220, the dynamic vision sensor may generate polarity information for each binning pixel group according to the selected type and address signals corresponding thereto. In an example embodiment, the dynamic vision sensor may perform an operation according to example embodiments with respect to pixels grouped in units of binning pixel groups corresponding to the selected type. In an example embodiment, the readout circuit of the dynamic vision sensor may be implemented to support the plurality of types.

In operation S230, the dynamic vision sensor may generate binned event data based on the polarity information and address signals generated in operation S220 and output the binned event data to the event data processor.

In operation S240, the dynamic vision sensor may generate polarity information for each pixel and address signals corresponding thereto from event signals output from the pixel array.

In operation S250, the dynamic vision sensor may generate event data based on the polarity information and address signals generated in operation S240 and output the event data to the event data processor.

The dynamic vision sensor may support multiple types of binning modes, each of which includes different binning pixel groups, so that the image device may variously adjust the amount of power consumption, data rate, etc.

FIG. 7A is a diagram showing the structure of a pixel PX of a dynamic vision sensor according to an example embodiment, and FIG. 7B is a diagram specifically showing the event detection circuit 220 of FIG. 7A.

Referring to FIG. 7A, the pixel PX may include a light reception circuit 210 and an event detection circuit 220.

In an example embodiment, the light reception circuit 210 may include a photodiode PD, a logarithmic amplifier LA, and a feedback transistor FB. The photodiode PD may be referred to as a photoelectric transformation element. In some example embodiments, the light reception circuit 210 may further include more photodiodes. The logarithmic amplifier LA may amplify a voltage corresponding to the photo current generated by the photodiode PD. The logarithmic amplifier LA may output a logarithmic voltage VLOG of a logarithmic scale. The feedback transistor FB may isolate the light reception circuit 210 from a differential circuit 221 of FIG. 7B.

In an example embodiment, the event detection circuit 220 may perform various processes on the logarithmic voltage VLOG. For example, the event detection circuit 220 may amplify a logarithmic voltage, compare the amplified logarithmic voltage with a reference voltage, determine whether the intensity of light incident on the photodiode PD increases or decrease, and output an event signal corresponding to the determined value (i.e., an on-event signal ON_EVT and an off-event signal OFF_EVT). The event detection circuit 220 may be reset by a reset signal RST after outputting the event signal.

Referring further to FIG. 7B, the event detection circuit 220 may include the differential circuit 221, a comparison circuit 222, and an event signal generation circuit 223.

In an example embodiment, the differential circuit 221 may amplify the logarithmic voltage VLOG and generate a voltage VDIFF indicating a change direction of the amplified logarithmic voltage VLOG. For example, the differential circuit 221 may include a switch element SW operated by capacitors CAP1 and CAP2, a differential amplifier DA, and a reset signal RST. Specifically, the capacitors CAP1 and CAP2 may store electrical energy generated by the photodiode PD. For example, capacitance capacities of capacitors CAP1 and CAP2 may be appropriately selected in consideration of the shortest time between two events that may occur consecutively in one pixel PX. When the switch element SW is switched on by the reset signal RST, the pixel PX may be initialized. In some example embodiments, the reset signal RST may be generated from the row address generator 140 of FIG. 3A or the column address generator 140′ of FIG. 4.

In an example embodiment, the comparison circuit 222 includes the comparators CP1 and CP2, and the comparison circuit 222 may compare the voltage VDIFF of the differential amplifier DA with the level of the reference voltage Vref through the comparators CP1 and CP2, and output the comparison results to the event signal generation circuit 223.

In an example embodiment, the event signal generation circuit 223 may determine whether an event detected in the pixel PX′ is an on-event or an off-event based on the comparison results received from the comparison circuit 222. For example, when an event in which the intensity of light increases by more than the reference value is detected, the event signal generation circuit 223 may output an on-event signal ON_EVT of logic high (H) and an off-event signal OFF_EVT of logic low (L). When an event in which the intensity of light decreases by more than the reference value is detected, the event signal generation circuit 223 may output an on-event signal ON_EVT of logic low (L) and an off-event signal OFF_EVT of logic high (H).

However, the configuration of the pixels PX shown in FIGS. 7A and 7B is only an example, and example embodiments are not limited thereto. Example embodiments may be applied to various pixels that detect events by detecting changing light intensity and generating detection results as event signals.

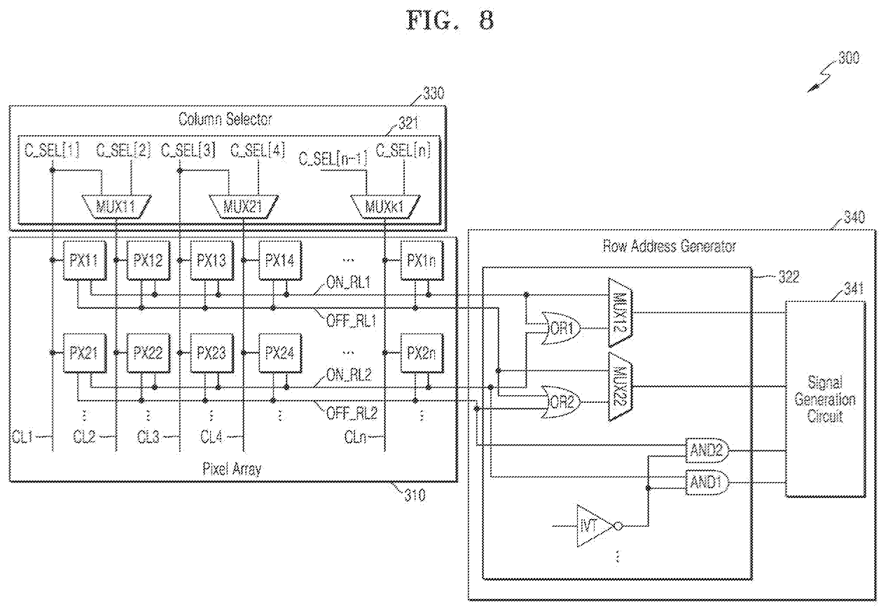

FIG. 8 is a detailed block diagram of a dynamic vision sensor 300 according to an example embodiment.

Referring to FIG. 8, the dynamic vision sensor 300 may include a pixel array 310, a column selector 330, and a row address generator 340.

In an example embodiment, the pixel array 310 may include pixels PX11, PX21, PX12, PX22, PX13, PX23, PX14, PX24, . . . , PX1n, and PX2n in which a plurality of columns and a plurality of rows are included. For example, pixels PX11, P12, PX13, PX14, . . . , and PX1n arranged in a first row may be connected to a first on-row line ON_RL1 and a first off-row line OFF_RL1, and pixels PX21, PX22, PX23, PX24, . . . , and PX2n arranged in a second row may be connected to a second on-row line ON_RL2 and a second off-row line OFF_RL2. In addition, for example, pixels PX11, PX21, . . . , and PXn1 arranged in a first column may be connected to a first column line CL1, pixels PX12, PX22, . . . , and PXn2 arranged in a second column may be connected to a second column line CL2, pixels PX13, PX23, . . . , and PXn3 arranged in a third column may connected to a third column line CL3, pixels PX14, PX24, . . . , and PXn4 arranged in a fourth column may be connected to a fourth column line CL4, and pixels PX1n, PX2n, . . . , and PXnn arranged in an n-th column are connected to an n-th column line CLn.

In an example embodiment, the column selector 330 includes a first readout sub-circuit 321, and the first readout sub-circuit 321 may include first-row-first-column (11) to k-th-row-first-column (k1) multiplexers MUX11, MUX21, . . . , and MUXk1. For example, the column selector 330 may sequentially generate first to n-th column selection signals C_SEL[1] to C_SEL[n]. For example, the first-row-first-column (11) multiplexer MUX11 may select one of a first column selection signal C_SEL[1] and a second column selection signal C_SEL[2] based on a selected mode and output the selected result to the second column line CL2. For example, the second-row-first-column (21) multiplexer MUX21 may select one of a third column selection signal C_SEL[3] and a fourth column selection signal C_SEL[4] based on a selected mode and output the selected result to the fourth column line CL4. For example, the k-th-row-first-column (k1) multiplexer MUXk1 may select one of an (n−1)-th column selection signal C_SEL[n−1] and an n-th column selection signal C_SEL[n] based on a selected mode and output the selected result to the n-th column line CLn.

In an example embodiment, the row address generator 340 includes a second readout sub-circuit 322 and a signal generation circuit 341, and the second readout sub-circuit 322 may include a plurality of multiplexers MUX12, MUX22, . . . , and MUXn2, a plurality of OR gates OR1, OR2, . . . , and ORn, a plurality of AND gates AND1, AND2, . . . , and ANDn, and a plurality of inverters IVT. For example, the inputs of the first OR gate OR1 may be connected to a first on-row line ON_RL1 and a second on-row line ON_RL2, and the inputs of the second OR gate OR2 may be connected to a first off-row line OFF_RL1 and a second off-row line OFF_RL2. For example, the first-row-second-column (12) multiplexer MUX12 may select either the signal of the first on-row line ON_RL1 or the output of the first OR gate OR1 based on the selected mode and output the selected result to the signal generation circuit 341. For example, the second-row-second-column (22) multiplexer MUX22 may select either the signal of the first off-row line OFF_RL1 or the output of the second OR gate OR2 based on the selected mode and output the selected result to the signal generation circuit 341. For example, an input of the first AND gate AND1 may be connected to the second on-row line ON_RL2 to selectively output a signal of the second on-row line ON_RL2 to the signal generation circuit 341. For example, an input of the second AND gate AND2 may be connected to the second off-row line OFF_RL2 to selectively output a signal of the second off-row line OFF_RL2 to the signal generation circuit 341. For example, the first AND gate AND1 and the second AND gate AND2 may be activated or deactivated based on the selected mode. Specifically, the first AND gate AND1 and the second AND gate AND2 may be activated or deactivated according to an output value of the inverter IVT.

The dynamic vision sensor 300 of FIG. 8 is only an example, and example embodiments are not limited thereto. Vision sensors may be implemented in various ways to perform operations according to the present disclosure.

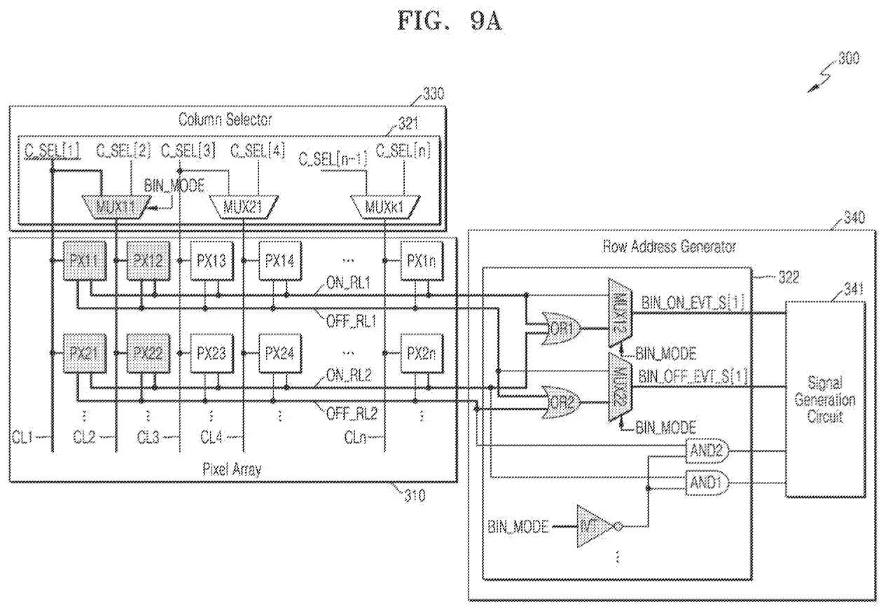

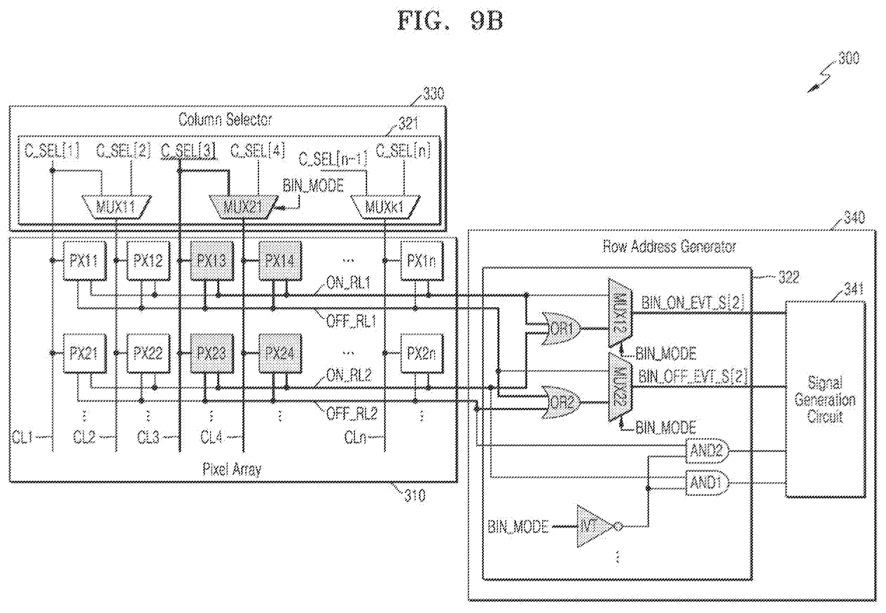

FIG. 9A is a diagram for explaining the operation of the dynamic vision sensor 300 of FIG. 8 in a first section of the binning mode, and FIG. 9B is a diagram for explaining the operation of the dynamic vision sensor 300 of FIG. 8 in a second section of the binning mode. Hereinafter, it is assumed that the second section follows the first section. Through the methods described in FIGS. 9A and 9B, the power consumption of the dynamic vision sensor 300 is reduced and the amount of data processed is reduced by reducing the number of times of samplings for the pixel array 310, so the image device may operate at a high speed frame rate.

Referring to FIG. 9A, the column selector 330 may generate a first column selection signal C_SEL[1]. The first column selection signal C_SEL[1] may be applied to the first column line CL1. The first-row-first-column (11) multiplexer MUX11 may route the first column selection signal C_SEL[1] to be applied to the second column line CL2 based on the binning mode control signal BIN_MODE.

The selected pixels PX11, PX21, PX12, and PX22 may be grouped into a first binning pixel group. Some pixels PX11 and PX12 of the selected pixels PX11, PX21, PX12, and PX22 may output on-event signals and off-event signals through the first on-row line ON_RL1 and the first off-row line OFF_RL1. The remaining pixels PX21 and PX22 of the selected pixels PX11, PX21, PX12, and PX22 may output on-event signals and off-event signals through the second on-row line ON_RL2 and the second off-row line OFF_RL2.

The first OR gate OR1 may OR-calculate a signal of the first on-row line ON_RL1 and a signal of the second on-row line ON_RL2 and output the OR-calculated result. The first-row-second-column (12) multiplexer MUX12 may select the output of the first OR gate OR1 based on the binning mode control signal BIN_MODE and output the selected output to the signal generation circuit 341 as a first binning on-event signal BIN_ON_EVT_S[1] corresponding to a first binning pixel group.

The second OR gate OR2 may OR-calculate a signal of the first off-row line OFF_RL1 and a signal of the second off-row line OFF_RL2 and output the OR-calculation result. The second-row-second-column (22) multiplexer MUX22 may select the output of the second OR gate OR2 based on the binning mode control signal BIN_MODE and output the selected output to the signal generation circuit 341 as a first binning off-event signal BIN_OFF_EVT_S[1] corresponding to a first binning pixel group.

For example, the binning mode control signal BIN_MODE may be a logic high signal, and the first AND gate AND1 and the second AND gate AND2 may be deactivated by the binning mode control signal BIN_MODE inverted by the inverter IVT.

Referring further to FIG. 9B, the column selector 330 may generate a third column selection signal C_SEL[3]. The third column selection signal C_SEL[3] may be applied to the third column line CL3. The second-row-first-column (21) multiplexer MUX21 may route the third column selection signal C_SEL[3] to be applied to the fourth column line CL4 based on the binning mode control signal BIN_MODE.

The selected pixels PX13, PX23, PX14, and PX24 may be grouped into a second binning pixel group. Some pixels PX13 and PX14 of the selected pixels PX13, PX23, PX14, and PX24 may output on-event signals and off-event signals through the first on-row line ON_RL1 and the first off-row line OFF_RL1. The remaining pixels PX23 and PX24 of the selected pixels PX13, PX23, PX14, and PX24 may output on-event signals and off-event signals through the second on-row line ON_RL2 and the second off-row line OFF_RL2.

The first OR gate OR1 may OR-calculate a signal of the first on-row line ON_RL1 and a signal of the second on-row line ON_RL2 and output the OR-calculated result. The first-row-second-column (12) multiplexer MUX12 may select the output of the first OR gate OR1 based on the binning mode control signal BIN_MODE and output the selected output to the signal generation circuit 341 as a second binning on-event signal BIN_ON_EVT_S[2] corresponding to a second binning pixel group.

The second OR gate OR2 may OR-calculate a signal of the first off-row line OFF_RL1 and a signal of the second off-row line OFF_RL2 and output the OR-calculation result. The second-row-second-column (22) multiplexer MUX22 may select the output of the second OR gate OR2 based on the binning mode control signal BIN_MODE and output the selected output to the signal generation circuit 341 as a second binning off-event signal BIN_OFF_EVT_S[2] corresponding to a second binning pixel group.

For example, the binning mode control signal BIN_MODE may be a logic high signal, and the first AND gate AND1 and the second AND gate AND2 may be deactivated by the binning mode control signal BIN_MODE inverted by the inverter IVT.

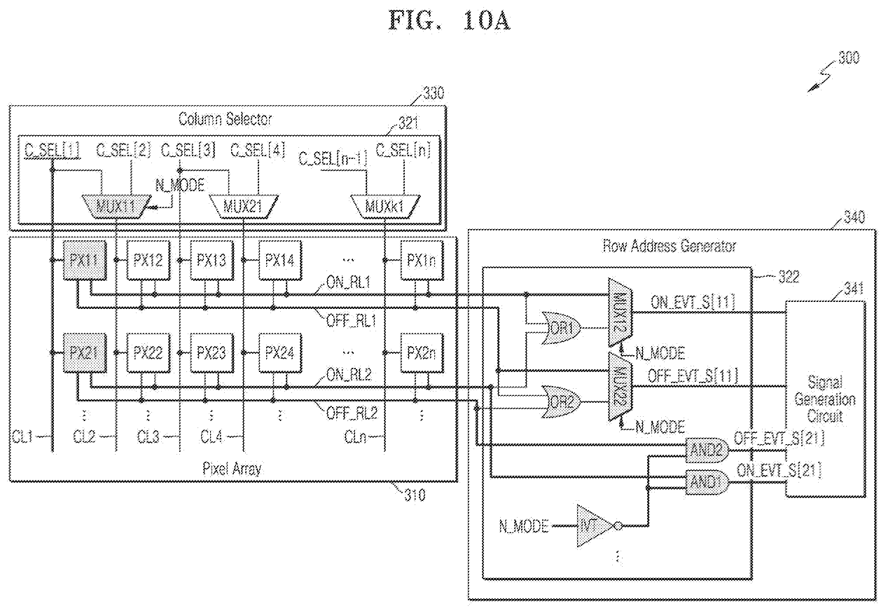

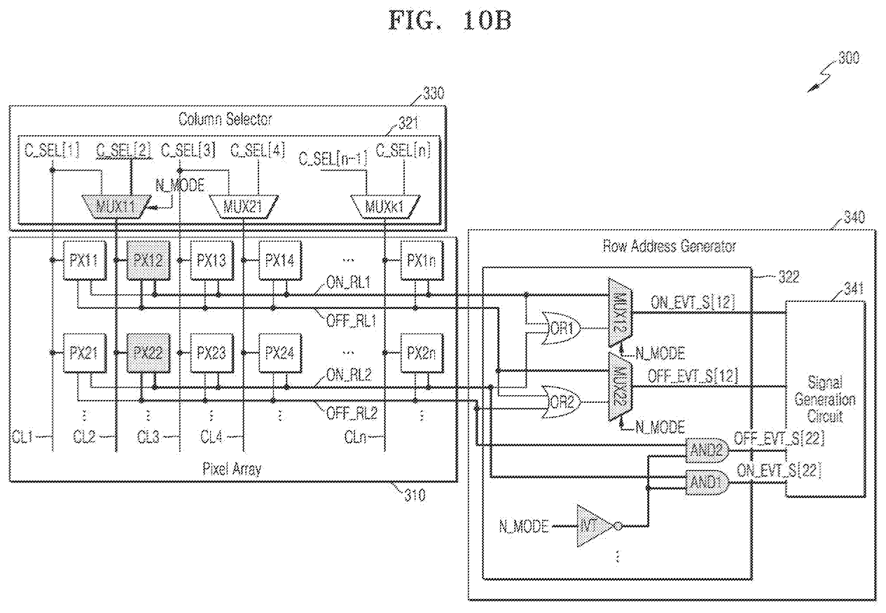

FIG. 10A is a diagram for explaining the operation of the dynamic vision sensor 300 of FIG. 8 in a first section of the normal mode, and FIG. 10B is a diagram for explaining the operation of the dynamic vision sensor 300 of FIG. 8 in a second section of the normal mode. Hereinafter, it is assumed that the second section follows the first section. Through the method described in FIGS. 10A and 10B, the image device may operate at a low-speed frame rate.

Referring to FIG. 10A, the column selector 330 may generate a first column selection signal C_SEL[1]. The first column selection signal C_SEL[1] may be applied to the first column line CL1. The first-row-first-column (11) multiplexer MUX11 may not output the first column selection signal C_SEL[1] to the second column line CL2 based on the normal mode control signal N_MODE.

One pixel PX11 of the selected pixels PX11 and PX21 may output an on-event signal and an off-event signal through the first on-row line ON_RL1 and the first off-row line OFF_RL1. The remaining one pixel PX21 of the selected pixels PX11 and PX21 may output an on-event signal and an off-event signal through the second on-row line ON_RL2 and the second off-row line OFF_RL2.

The first-row-second-column (12) multiplexer MUX12 may select a signal of the first on-row line ON_RL1 based on the normal mode control signal N_MODE and output the selected signal to the signal generation circuit 341 as the first on-event signal ON_EVT_S[11]. The second-row-second-column (22) multiplexer MUX22 may select a signal of the first off-row line OFF_RL1 based on the normal mode control signal N_MODE and output the selected signal to the signal generation circuit 341 as the first off-event signal OFF_EVT_S[11].

For example, the normal mode control signal N_MODE may be a logic low signal, and the first AND gate AND1 and the second AND gate AND2 may be activated by the normal mode control signal N_MODE inverted by the inverter IVT. The first AND gate AND1 may output a signal of the second on-row line ON_RL2 to the signal generation circuit 341 as a second on-event signal ON_EVT_S[21]. The second AND gate AND2 may output a signal of the second off-row line OFF_RL2 to the signal generation circuit 341 as a second off-event signal OFF_EVT_S[21].

Referring further to FIG. 10B, the column selector 330 may generate a second column selection signal C_SEL[2]. The first-row-first-column (11) multiplexer MUX11 may route the second column selection signal C_SEL[2] to be applied to the second column line CL2 based on the normal mode control signal N_MODE.

One pixel PX12 of the selected pixels PX12 and PX22 may output an on-event signal and an off-event signal through the first on-row line ON_RL1 and the first off-row line OFF_RL1. The remaining one pixel PX22 of the selected pixels PX12 and PX22 may output an on-event signal and an off-event signal through the second on-row line ON_RL2 and the second off-row line OFF_RL2.

The first-row-second-column (12) multiplexer MUX12 may select a signal of the first on-row line ON_RL1 based on the normal mode control signal N_MODE and output the selected signal to the signal generation circuit 341 as the third on-event signal ON_EVT_S[12]. The second-row-second-column (22) multiplexer MUX22 may select a signal of the first off-row line OFF_RL1 based on the normal mode control signal N_MODE and output the selected signal to the signal generation circuit 341 as the third off-event signal OFF_EVT_S[12].

For example, the normal mode control signal N_MODE may be a logic low signal, and the first AND gate AND1 and the second AND gate AND2 may be activated by the normal mode control signal N_MODE inverted by the inverter IVT. The first AND gate AND1 may output a signal of the second on-row line ON_RL2 to the signal generation circuit 341 as a fourth on-event signal ON_EVT_S[22]. The second AND gate AND2 may output a signal of the second off-row line OFF_RL2 to the signal generation circuit 341 as a fourth off-event signal OFF_EVT_S[22].

FIG. 11 is a detailed block diagram of a dynamic vision sensor 400 according to an example embodiment. Hereinafter, structural differences from the dynamic vision sensor 300 of FIG. 8 will be chiefly described.

Referring to FIG. 11, the dynamic vision sensor 400 may include a pixel array 410, a column selector 430, and a row address generator 440.

In an example embodiment, the pixel array 410 may include pixels PX11′, PX21′, PX13′, PX23′, PX14′, PX24′, PX1n′, . . . , PX1n′, and PX2n′ and a plurality of event detection circuits 411_1, 411_2, . . . , and 411_n, which are arranged into a plurality of columns and a plurality of rows.

Unlike the pixels PX11, PX21, PX12, PX22, PX13, PX23, PX14, PX24, . . . , PX1n, and PX2n of FIG. 8, the pixels PX11′, PX21′, PX12′, PX22′, PX13′, PX23′, PX14′, PX24′, . . . , PX1n′, and PX2n′ of FIG. 11 do not include the event detection circuits. Rather, the pixel array 410 includes a plurality of event detection circuits 411_1, 411_2, . . . , 411-n that are separate from the pixels and are arranged on the pixel array 410.

For example, pixels PX11′, P12′, PX13′, PX14′, . . . , and PX1n′ arranged in the first row may be connected to the first row line RL1, and pixels PX21′, PX22′, PX23′, PX24′, . . . , and PX2n′ arranged as the second row may be connected to the second row line RL2.

The above-described example embodiments may be applied to the dynamic vision sensor 400 of FIG. 11, and detailed descriptions thereof will be omitted.

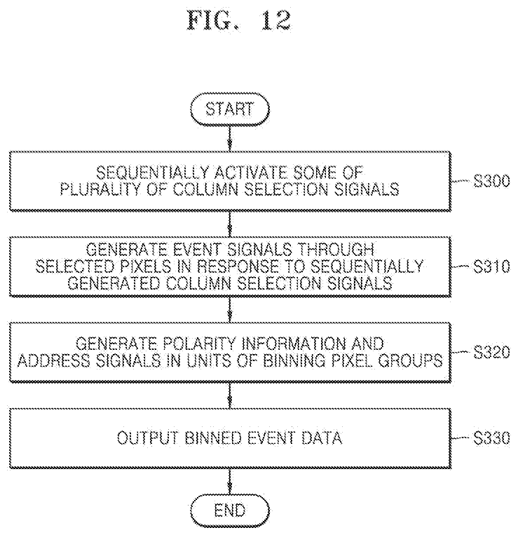

FIG. 12 is a flowchart illustrating a method of operating a dynamic vision sensor in a binning mode according to an example embodiment.

Referring to FIG. 12, in operation S300, the dynamic vision sensor may sequentially generate some of a plurality of column selection signals.

In operation S310, the dynamic vision sensor may generate event signals through pixels selected in response to sequentially generated column selection signals.

In operation S320, the dynamic vision sensor may generate polarity information and address signals in units of binning pixel groups.

In operation S330, the dynamic vision sensor may output the binned event data based on the polarity information and the address signals generated in operation S320.

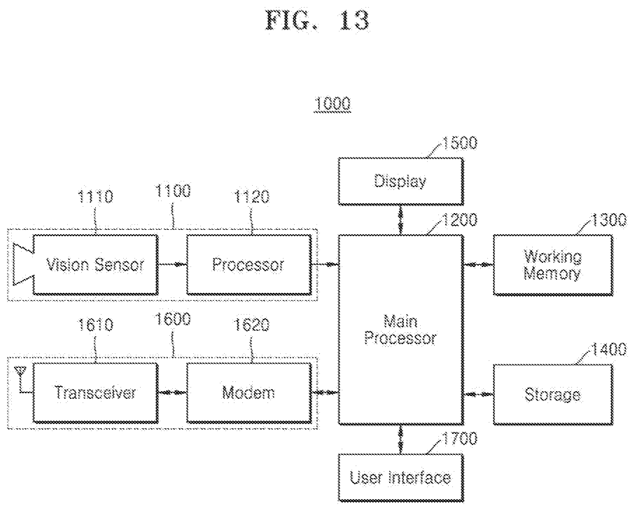

FIG. 13 is a block diagram illustrating an electronic device 1000 according to an example embodiment.

For example, the electronic device 1000 may be implemented as a smartphone, a tablet computer, a desktop computer, a laptop computer, or a wearable device. Furthermore, the electronic device 1000 may be implemented as one of the various types of electronic devices required to operate an unmanned security system, the Internet of Things, or an autonomous vehicle.

Referring to FIG. 13, the electronic device 1000 may include an image device 1100, a main processor 1200, a working memory 1300, a storage 1400, a display 1500, a communication block 1600 and a user interface 1700.

The description above, with reference to FIGS. 1 to 12, may be applied to the image device 1100. Specifically, the image device 1100 may include a vision sensor 1110 and a processor 1120, and the vision sensor 1110 may include a readout circuit of example embodiments.

The working memory 1300 may store data used for an operation of the electronic device 1000. For example, the working memory 1300 may temporarily store packets or frames processed by the processor 1120. For example, the working memory 1300 may include volatile memory such as dynamic RAM (DRAM) and synchronous DRAM (SDRAM), and/or nonvolatile memory such as phase-change RAM (PRAM), magnetic-resistive RAM (MRAM), resistive RAM (ReRAM), and ferro-electrical RAM (FRAM).

The storage 1400 may store firmware or software for driving the electronic device 1000. The firmware or software may be read from the storage 1400 according to a request or command of the main processor 1200 and the read firmware or software may be loaded into the working memory 1300. The storage 1400 may include a nonvolatile memory such as flash memory, PRAM, MRAM, ReRAM, or FRAM.

The display 1500 may include a display panel and a display serial interface (DSI) peripheral circuit. For example, the display panel may be implemented as various devices such as a liquid crystal display (LCD) device, a light emitting diode (LED) display device, an organic LED (OLED) display device, and an active matrix OLED (AMOLED) display device. A DSI host embedded in the main processor 1200 may perform serial communication with the display panel through a DSI. The DSI peripheral circuit may include a timing controller, a source driver, and the like necessary to drive the display panel.

The communication block 1600 may exchange signals with an external device/system through an antenna. A transceiver 1610 and a modulator/demodulator (modem) 1620 of the communication block 1600 may process signals exchanged with an external device/system according to a wireless communication protocol such as long term evolution (LTE), worldwide interoperability for microwave access (WiMAX), global system for mobile communication (GSM), code division multiple access (CDMA), Bluetooth, near field communication (NFC), wireless fidelity (Wi-Fi), and radio frequency identification (RFID).

The user interface 1700 may include at least one of input interfaces such as a keyboard, mouse, keypad, button, touch panel, touch screen, touch pad, touch ball, gyroscope sensor, vibration sensor, and acceleration sensor.

The components of the electronic device 1000 may exchange data based on one or more of various interface protocols such as universal serial bus (USB), small computer system interface (SCSI), peripheral component interconnect express (PCIe), mobile PCLe (M-PCIe), advanced technology attachment (ATA), parallel ATA (PATA), serial ATA (SATA), serial attached SCSI (SAS), integrated drive electronics (IDE), enhanced IDE (EIDE), nonvolatile memory express (NVMe), and universal flash storage (UFS).

While aspects of example embodiments have been particularly shown and described, it will be understood that various changes in form and details may be made therein without departing from the spirit and scope of the following claims.

What is claimed is:

1. A dynamic vision sensor comprising:
a pixel array comprising a plurality of pixels arranged in a plurality of rows and a plurality of columns, wherein each of the plurality of pixels is configured to detect a change in intensity of incident light; and
a readout circuit configured to simultaneously select first pixels of first target columns among the plurality of columns in a first section of a binning operation, and generate and output first binning event signals of first binning pixel groups based on first event signals simultaneously output from the first pixels.

2. The dynamic vision sensor of claim 1, wherein the readout circuit is further configured to simultaneously select second pixels of second target columns among the plurality of columns in a second section of the binning operation following the first section, and to generate and output second binning event signals of second binning pixel groups based on second event signals simultaneously output from the second pixels.

3. The dynamic vision sensor of claim 2, wherein the second target columns are adjacent to the first target columns.

4. The dynamic vision sensor of claim 1, wherein each of the first binning pixel groups comprises pixels arranged in an M×N array (where each of M and N is an integer equal to or greater than 2).

5. The dynamic vision sensor of claim 4, wherein the readout circuit is further configured to adjust at least one of M and N according to a type of the binning operation.

6. The dynamic vision sensor of claim 1, wherein the readout circuit is further configured to, in a normal mode, sequentially select the plurality of columns and output event signals corresponding to the plurality of pixels output from the pixel array in units of rows.

7. The dynamic vision sensor of claim 1, wherein each of the plurality of pixels comprises:
a photoelectric transformation element configured to accumulate charges corresponding to the incident light;
a light reception circuit configured to output a logarithmic voltage based on a photoelectric current corresponding to the accumulated charges; and
an event detection circuit configured to amplify the logarithmic voltage, compare the amplified logarithmic voltage with a reference voltage, identify the change in the intensity of the incident light, and output an event signal corresponding to the change.

8. The dynamic vision sensor of claim 1, wherein each of the plurality of pixels comprises:
a photoelectric transformation element configured to accumulate charges corresponding to the incident light; and
a light reception circuit configured to output a logarithmic voltage based on a photoelectric current corresponding to the accumulated charges, and
wherein the pixel array further comprises a plurality of event detection circuits configured to compare the logarithmic voltage from the plurality of pixels with a reference voltage to identify the change in the intensity of the incident light, and to output an event signal corresponding to the change.

9. The dynamic vision sensor of claim 8, wherein the plurality of event detection circuits respectively correspond to the plurality of rows on a one-to-one basis.

10. The dynamic vision sensor of claim 1, further comprising:
a column selection circuit configured to generate a column selection signal simultaneously selecting the first pixels in the first section; and
a row address generator configured to generate row address signals corresponding to the first binning event signals in the first section,
wherein the readout circuit comprises:
a first readout sub-circuit comprising a first multiplexer configured to route the column selection signal to be simultaneously applied to each of the first pixels in the first section; and
a second readout sub-circuit comprising a plurality of OR gate gates configured to generate the first binning event signals in the first section and a plurality of second multiplexers configured to route the first binning event signals from the plurality of OR gates.

11. The dynamic vision sensor of claim 10, wherein the first readout sub-circuit is provided adjacent the column selection circuit, and the second readout sub-circuit is provided adjacent the row address generator.

12. The dynamic vision sensor of claim 1, wherein the readout circuit comprises a digital logic circuit.

13. A dynamic vision sensor comprising:
a first dynamic vision sensor (DVS) pixel connected to a first column line, a first on-row line, and a first off-row line;
a second DVS pixel connected to the first column line, a second on-row line, and a second off-row line;
a third DVS pixel connected to a second column line, the first on-row line, and the first off-row line;
a fourth DVS pixel connected to the second column line, the second on-row line, and the second off-row line;
a first readout sub-circuit comprising a first multiplexer configured to select a selected signal from among a first column selection signal and a second column selection signal applied to the first column line based on a mode of the dynamic vision sensor, and output the selected signal to the second column line; and
a second readout sub-circuit comprising:
a first OR gate connected to the first on-row line and the second on-row line through inputs;
a second multiplexer configured to select and output one of an output of the first OR gate and a signal of the first on-row line based on the mode;
a second OR gate connected to the first off-row line and the second off-row line through inputs;
a third multiplexer configured to select and output one of an output of the second OR gate and a signal of the first off-row line based on the mode;
a first AND gate configured to selectively output a signal of the second on-row line based on the mode; and
a second AND gate configured to selectively output a signal of the second off-row line based on the mode.

14. The dynamic vision sensor of claim 13, wherein, based on the mode being a binning mode;
the first multiplexer is further configured to select and output the first column selection signal to the second column line,
the second multiplexer is further configured to select an output of the first OR gate,
the third multiplexer is further configured to select an output of the second OR gate, and
the first AND gate and the second AND gate are further configured to be disabled.

15. The dynamic vision sensor of claim 14, further comprising a row address generator configured to output at least one of the output of the first OR gate and the output of the second OR gate as a binning event signal, and to output a row address signal corresponding to the binning event signal.

16. The dynamic vision sensor of claim 15, wherein the first to fourth DVS pixels are included in one binning pixel group, and the row address signal corresponds to a row address of any one of the first to fourth DVS pixels.

17. The dynamic vision sensor of claim 13, wherein, when based on the mode being a normal mode:
the first multiplexer is further configured to select and output the second column selection signal to the second column line while the first column selection signal is applied to the first column line,
the second multiplexer is further configured to select a signal of the first on-row line,
the third multiplexer is further configured to select a signal of the first off-row line,
the first AND gate is further configured to be enabled and output a signal of the second on-row line, and
the second AND gate is further configured to be enabled and output a signal of the second off-row line.

18. A dynamic vision sensor comprising:
a pixel array comprising a plurality of pixels arranged in a plurality of rows and a plurality of columns, wherein each of the plurality of pixels is configured to detect a change in intensity of incident light; and
a readout circuit configured to sequentially select binning pixel groups of the plurality of pixels in units of columns in a binning operation and generate and output binning event signals of the binning pixel groups based on a plurality of event signals output from the binning pixel groups.

19. The dynamic vision sensor of claim 18, wherein the readout circuit is further configured to sequentially select the plurality of pixels in units of columns in a normal mode and to output event signals output from selected pixels in units of rows.

20. The dynamic vision sensor of claim 18, further comprising
a column selection circuit configured to generate column addresses corresponding to the binning event signals;
a row address generation circuit configured to generate row addresses corresponding to the binning event signals; and
an output buffer configured to generate event data based on the binning event signals, the column addresses, and the row addresses.
